(19) United States
(12) Patent Application Publication
(10) Pub. No.: US 2005/0008853 A1
(43) Pub. Date: Jan. 13, 2005

(54) Disposable Absorbent Sheet

(76) Inventor: Frederick C. Foote, Haslett, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/604,294

(22) Filed: Jul. 9, 2003

(51) Int. Cl. B32B 7/12; A61F 13/15

(52) U.S. Cl. 428/343; 604/358

(57) ABSTRACT

A disposable sheet of absorbent material including at least one adhesive element on a bottom surface to releasably secure the sheet to a floor or other surface. The sheet may be included in a pad or roll containing a plurality of such sheets adhesively and releasably connected together. A pad of such sheets may include a hole through the sheets to enable the pad to be stored on a hook. The sheets may be configured in a variety of different shapes to conform to different sized toilets and urinals and may include decorative graphics, writings, and various colors or textures to provide a means of advertising, concealing drips and stains, and improving the appearance of a restroom. The sheets may also be configured to be used at the bottom of bird cages, small animal cages, the floors of kitchens and foodservice areas of restaurants.

### FIELD OF THE INVENTION

The present invention relates to a disposable, absorbent sheet of paper or other suitable material for adhesive installation in front of urinals and toilets in public restrooms, at the bottom of small animal or bird cages, on the floors of kitchen or foodservice areas in restaurants, and other suitable locations. The invention especially relates to pads or rolls of such sheets, each pad or roll containing a plurality of sheets affixed to one another by a strip of light to moderately tacky adhesive at a location on the underside of each sheet in a manner analogous to the POST-IT pads of adhesive notes commonly used to annotate office documents.

### DISCUSSION OF PRIOR ART

Attempts are known in the art to maintain sanitary conditions in restrooms near toilets and wall-mounted urinals using trays, mats, or sheets, particularly in public restrooms for men where unwanted moisture, odor and bacteria on the floors commonly present both sanitary and aesthetic problems. For example, U.S. Pat. No. 4,125,656 to Creamer shows a pleated absorbent sheet for use around the base of a pedestal toilet to absorb moisture. Unfortunately, the pleated Creamer sheet is small and only suitable to absorb condensation dripping down the sides of the pedestal of a toilet. As such, it is not at all suitable for use at a wall-mounted urinal. Further, even at the base of a toilet it is not suitable for a user to stand upon or directly over and, therefore, does not aid in collecting drips or spills attributable to the user himself. The time-consuming and complicated pleating, folding, and adjustment features of the Creamer sheet further reduce the utility of this invention as it is expensive to manufacture and difficult to install.

Other absorbent sheets in the prior art are designed to be held within bulky, rigid and non-disposable trays. These trays themselves are subject to odor, moisture, and unsanitary bacteria. They are also expensive to manufacture and often unattractive. Thus, they potentially do not save in cleaning time, nor do they necessarily provide the desired improved sanitary environment.

Of concern is the risk of an absorbent sheet slipping out of position while in use. Again, unsatisfactory attempts to prevent this problem exist in the prior art. Some embodiments secure a sheet or a collection of sheets through use of strings, tape, or staples. These additional materials make the sheets both more difficult to manufacture and more time-consuming to install and remove. For example, U.S. Pat No. 2,057,162 to Richey utilizes strings to tie absorbent sheets to toilet pedestals. Not only would the Richey sheet be difficult to install, but it would be unsanitary as well since the attendant would have to reach behind the toilet to install the device.

In short, there is a desire and need in the art for an absorbent sheet of paper or other suitable material for use in restrooms and elsewhere that combines the benefits of being sanitary, capable of absorbing moisture and odor, inexpensive, secure, easy to install, easy to remove, easy to manufacture, capable of containing advertising or other messages to the user, capable of incorporating scented or antibacterial properties, easy to store in the form of self-contained pads or rolls of such sheets, and also providing an aesthetically pleasing appearance.

### SUMMARY OF INVENTION

The present invention provides for a disposable, absorbent sheet suited for use around the base of a toilet, under a urinal, at the bottom of bird or animal cages, or on the floors of kitchen or foodservice areas in restaurants, and that may be simply and effectively secured to and removed from a floor or other surface in an efficient manner by means of a light to moderately tacky adhesive element.

In one embodiment of the present invention, a sheet for absorbing fluids and soils adjacent to the base of a urinal may include an adhesive strip on the underside of the sheet's edge lying furthest from the restroom wall. The adhesive strip releasably secures the sheet to a floor surface and is configured to enable a user to stand upon part of the sheet without inadvertently detaching it from the floor.

In another embodiment of the present invention, a sheet for absorbing fluids and soils adjacent to the base of a toilet also includes a semi-circular, rectangular, or other suitably shaped “cut-out” that permits the sheet to be installed around the toilet's pedestal. This sheet is also configured to enable a user standing in front of or over the toilet to stand upon part of the sheet without inadvertently detaching it from the floor.

In another embodiment of the present invention, a sheet for absorbing fluids and soils includes an adhesive element on a bottom surface to releasably secure the sheet to the bottom of a bird cage or animal cage.

In another embodiment of the present invention, a large roll of absorbent material has light to moderately tacky adhesive strips along both edges running the length of the sheet making it suitable for the floors of kitchens or foodservice areas in restaurants where moisture and food spills make those areas both unsanitary and dangerous.

In yet another embodiment of the present invention, a method of using a plurality of sheets in the form of a pad of such sheets includes the steps of: removing a first sheet from a pad including a plurality of absorbent sheets; adhesively securing the first sheet to a surface; discarding the first sheet as it becomes soiled; removing a second sheet from the pad; and adhesively securing the second sheet to a surface.

In yet another embodiment of the present invention, a method of using a plurality of sheets in the form of a continuous roll includes the steps of: pulling and then tearing a desired length of absorbent material from a continuous roll; adhesively securing the first sheet to a surface; discarding the first sheet as it becomes soiled; pulling and then tearing a second desired length of absorbent material from the continuous roll; and adhesively securing the second sheet to a surface.

In all embodiments of the present invention, a plurality of disposable sheets of absorbent material may be manufactured and conveniently stored in the form of pads or rolls of such sheets. The adhesive element both connects the plurality of sheets to one another and also permits them to be removed from the pad or roll and then adhesively secured to a floor or other surface. Such pads or rolls may be stacked and stored horizontally or vertically and, in the case of pads of such sheets, may also be hung vertically from a prefabricated hole near the edge of the pad.

Other features of the present invention will become more apparent to persons having ordinary skill in the art to which the present invention pertains from the following description and claims taken in conjunction with the accompanying companying figures.

### BRIEF DESCRIPTION OF DRAWINGS

The foregoing features, as well as other features, will become apparent with reference to the description and figures below in which like numerals represent like elements and in which:

FIG. 1 is a perspective view of a sheet of the present invention positioned adjacent to a toilet base;

FIG. 2 is a perspective view of sheets of the present invention positioned beneath a pair of urinals;

FIG. 3 is a plan view of an embodiment of a pad of the present invention;

FIG. 4 is a perspective view of a sheet of the present invention positioned at the bottom of a small animal cage;

FIG. 5 is a perspective view of a sheet of the present invention positioned at the bottom of a bird cage;

FIG. 6 is a sectional view taken along line 6-6 in FIG. 3; and

FIGS. 7a and 7b are perspective views of an embodiment of the present invention in the configuration of a continuous roll of sheets.

### DETAILED DESCRIPTION

The present invention is a disposable, absorbent sheet suitable for adhesive installation in front of urinals and toilets, at the bottom of bird or animal cages, on the floors of kitchen or foodservice areas in restaurants, and other suitable locations. The invention provides a remedy for unsightly and unsanitary moisture, odor, and bacteria that commonly forms at the base of urinals and toilets and typically remains until the next scheduled mopping. In addition to soiling and creating an offensive odor in public restrooms, these conditions are inevitably tracked back into the more public areas they serve such as restaurants, bars, gas stations, hotel lobbies, airline terminals, offices, schoolrooms, retail spaces, nursing homes and the like. The present invention provides a low cost-per-unit solution that is securable, capable of absorbing moisture and odor, easy to install, easy to manufacture, capable of incorporating scented or antibacterial properties, and easy to store, while also providing an aesthetically pleasing appearance. The invention's low per-unit cost, ease of installation, and ease of removal allow it to be replaced on a daily or, in some cases, on an even more frequent basis as needed.

Described in more detail below are specific embodiments of the present invention, one for use under a urinal, another for under a pedestal toilet, a third for use at the bottom of a small animal cage or bird cage, and a fourth in the configuration of a continuous roll. Under a wall-mounted urinal, the present invention may be a simple, rectangular sheet of absorbent paper large enough to catch drips and spills, large enough to permit a printed message or advertising, and simple enough in shape (i.e., no tapering or cut-outs) to make it easy and inexpensive to manufacture. The sheet may be single- or multi-ply paper and with or without a non-absorbent (waxy) backing. It should be highly-absorbent and, further, may be scented, may be infused with an antibacterial material, and may be textured and/or printed so as to conceal stains or drips. A single adhesive strip on the underside of each sheet may run the width of the sheet and be positioned on the edge of the sheet farthest away from the restroom wall. Other embodiments of the invention could have the adhesive strip at both ends (or even at all four sides) of the absorbent sheet. It is anticipated, however, that a single strip positioned away from the restroom wall and under the feet of the user would be less expensive to manufacture, easier to install, and easier to remove from restroom floors, while providing sufficient adhesion to a restroom floor.

An alternate embodiment for use at the base of a pedestal toilet would further include a cut-out to allow the sheet to extend around the pedestal and thus further underneath the bowl of the toilet.

An alternate embodiment for use at the bottom of a small animal or bird cage could also include additional adhesive elements as friction may be applied anywhere on the sheet rather than primarily along one edge.

An alternate embodiment for use on the floors of kitchen or foodservice areas in restaurants would include adhesive elements on both sides of a large, continuous roll of paper or other absorbent material.

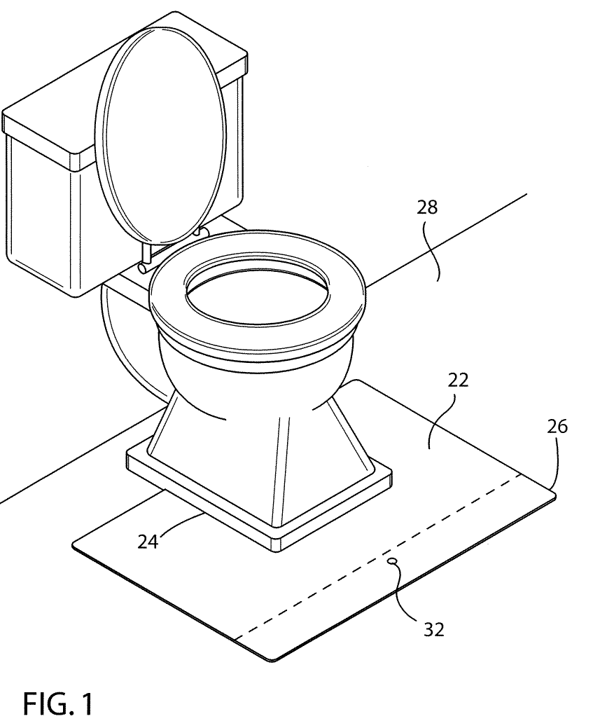

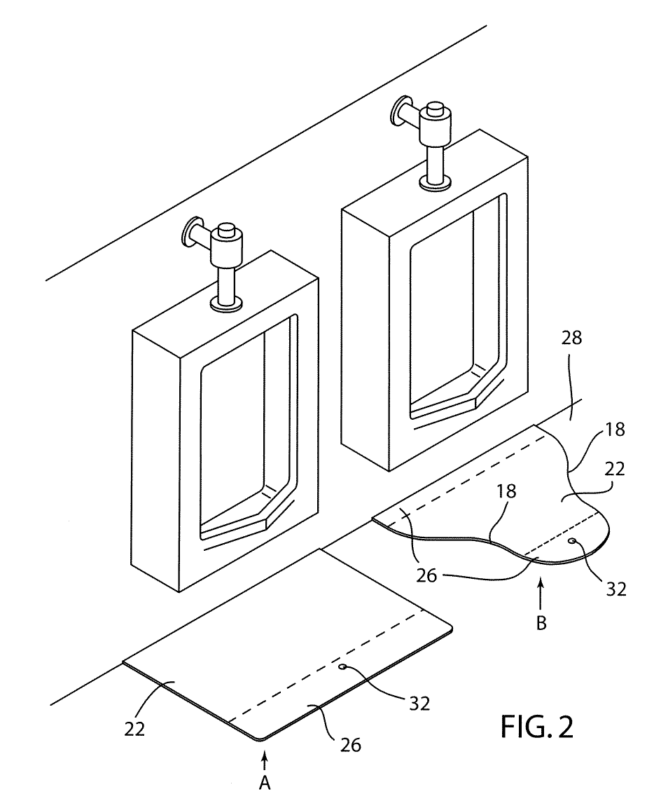

Referring specifically to the figures, two embodiments of the present invention are illustrated in use under a pedestal toilet (FIG. 1) and a wall mounted urinal (FIG. 2). In each case, a sheet 22 may be positioned adjacent to a toilet or urinal. The sheet 22 may be made of a variety of different materials including various grades of absorbent and resilient paper or other material and be similar to a thick and slightly stiffened “paper towel” or “shop towel.” Single- or multi-ply absorbent papers, with or without a non-absorbent (waxy) backing, and with or without a thin or infused layer of specialized odor-absorbing materials such as carbon may be utilized. Further, the thickness and degree of absorbency of the material used may vary depending on the needs and desire of the user.

As shown, sheet 22 may be configured in a variety of different shapes and sizes to accommodate the use in front of different toilet and urinal configurations. For example, FIG. 1 shows a rectangle having a cut-out 24. In FIG. 2, two embodiments of sheet 22 are shown, a rectangular shaped embodiment indicated at A and an embodiment with external cut-outs 18 indicated at B. In the embodiment of FIG. 2B, the user is not intended to have his feet contact sheet 22. Therefore, dirt and soils transferred from users will accumulate at a reduced rate and may increase the usable life of sheet 22.

In all embodiments of the present invention, sheet 22 includes an adhesive element 26 on a bottom surface such as an adhesive strip along an edge of sheet 22 as shown in the figures. Adhesive element 26 may be any material having a light to moderate tackiness capable of both holding each sheet securely to a floor surface 28 and to an adjacent sheet in a pad as described below, while also allowing easy installation and removal. In a preferred embodiment, adhesive element 26 runs the entire length of one edge as shown in FIG. 1. The adhesive element 26 may be approximately 5.1 cm to 12.7 cm (2 inch to 5 inches) in width. Alternatively, the adhesive element 26 may be located under any of the peripheral edges, around the entire periphery of the sheet, or even under the entire underside of sheet 22. Further, the adhesive element 26 may be continuous or (to save on manufacturing or material costs) spotted or segmented. Alternatively, adhesive element 26 may include any of a variety of different shapes and sizes and be positioned at a variety of locations on the bottom surface of sheet 22.

Adhesive element 26 enables sheet 22 to be secured to the floor surface 28 to reduce the chance of a sheet 22 slipping out of position while in use and thereby preventing a littered and unsightly appearance. Using adhesive element 26, sheets 22 are easily installed, easily removed and easily suited for use on a variety of surfaces including metal or glass (in the case of animal cages), tile, concrete, wood, or even carpeted floors. Further, the adhesive element 26 is compatible with an endless variety of either single- or multi-ply absorbent sheet papers, with or without non-absorbent (waxy) backings.

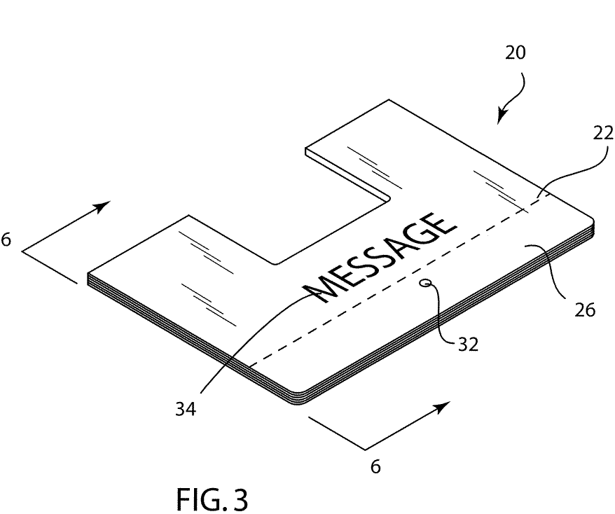

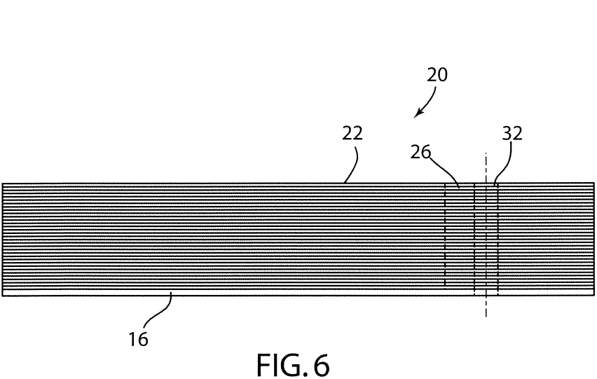

Adhesive element 26 also enables a plurality of sheets 22 to be adhesively and releasably connected vertically on top of one another to form pad 20 as shown in FIGS. 3 and 6. Again, this would be a similar configuration to the sheets of paper in a POST-IT note pad. Each sheet 22 is individually peeled off pad 20 as needed. As shown in FIG. 6, a base sheet 16 may be included and adhesively affixed to the bottommost sheet 22 in pad 20. Base sheet 16 may be constructed of the same material as sheets 22 or other suitable materials such as a wax paper to cover and protect the adhesive element 26 on the bottommost sheet 22 of pad 20.

Sheet 22 and a resultant pad 20 may also include a hole 32 as shown in the figures. Hole 32 permits pad 20 to be stored vertically on a hook or peg. Multiple pads 20 may be stacked vertically or horizontally in a storage area, or alternatively may be hung on a peg or hook in a storage room or other location convenient for use near a toilet or urinal. This improved storageability over separate and loose sheets prevents possible damage from wrinkling, tearing, or fluid spills caused by contact with other objects or by individual sheets falling off a shelf within a storage area or facility.

Sheet 22 may also include decorative graphics or text to provide a more aesthetically pleasing appearance. For example, printed colors or geometric or swirling patterns that help hide drips and stains may improve the overall appearance of sheets 22 before, during, and after use. As shown in FIG. 3, a message 34, such as the name of the product itself or the establishment utilizing the product (e.g., the name of a hotel or restaurant chain) may also be printed on a top surface of sheets 22. Sheet 22 may also include other desirable features such as infused fragrance or antibacterial chemicals (not shown).

In use, as shown in FIGS. 1 and 2, sheet 22 may be peeled from pad 20 and positioned adjacent to a urinal or toilet to provide a means to absorb fluids that may drip or splash from the toilet, urinal or user. As the sheet 22 that is in use becomes soiled, it may be easily removed from the floor surface 28 and disposed. A clean sheet 22 may then be peeled from pad 20 and positioned on floor surface 28. This process may continue until all of the plurality of sheets 22 in pad 20 have been depleted.

As sheets 22 are removed from the position next to a toilet or urinal to be discarded, they may also serve as a large, resilient and absorbent paper towel for a bathroom attendant to further clean other moist areas within a restroom. This additional utility would be dependent on the stiffness of the paper used, whether it utilizes a non-absorbent backing, and how soiled it may be after a toilet or urinal has been visited many times. In this regard, sheet 22 is superior to prior art in that it requires no strings, pleats, staples, or tape to attach it to floor surface 28 and that might hinder its usefulness as a paper towel. Even if a restroom floor is wet from an overnight mopping, for instance, sheet 22 could be adhesively affixed (“posted”) to the wall next to each urinal or toilet with adhesive element 26 as a means of making sheet 22 easily accessible for later installation.

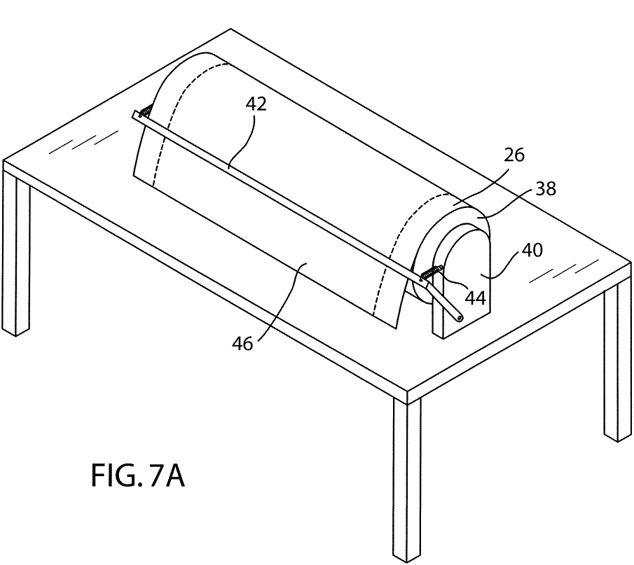

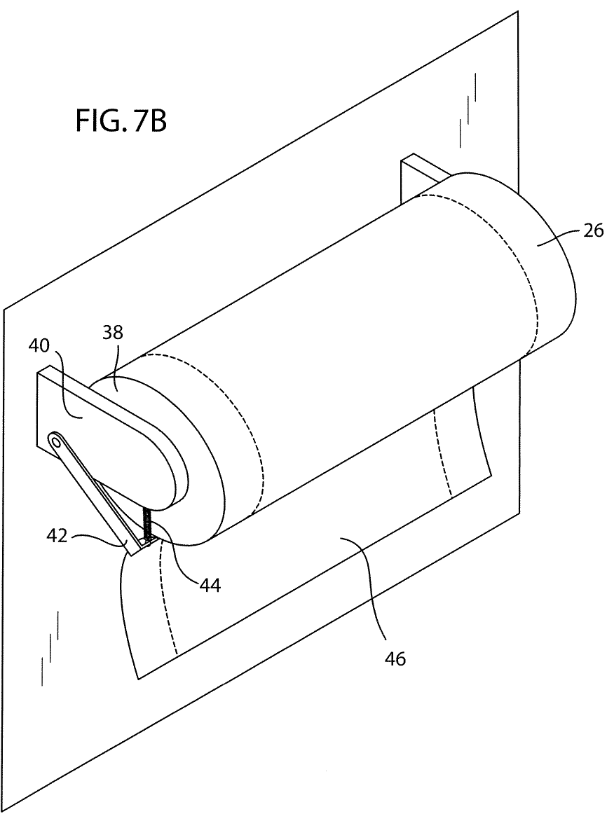

In another embodiment of the present invention, sheet 22 may be configured from a continuous roll of absorbent material 38 as shown in FIGS. 7a and 7b. In this embodiment one or both edges of the roll of absorbent material 38 may include adhesive element 26 in the form of an adhesive strip. The roll of absorbent material 38 may be placed on a spool dispenser 40 or one similar to a dispenser of paper towels. Spool dispenser 40 may be mounted on a wall (FIG. 7b) or alternatively placed or attached on a surface such as a table top (FIG. 7a). Spool dispenser 40 may also include a cutting edge 42 and a pair of springs 44. A user may pull on the exposed end of the roll 38 until a desired section 46 of absorbent material is obtained, and then cut section 46 with cutting edge 42. Springs 44 impress cutting edge 42 upon the roll of absorbent material 38. Therefore as sections 46 are removed, cutting edge 42 applies consistent pressure upon the increasingly smaller roll of absorbent material 38.

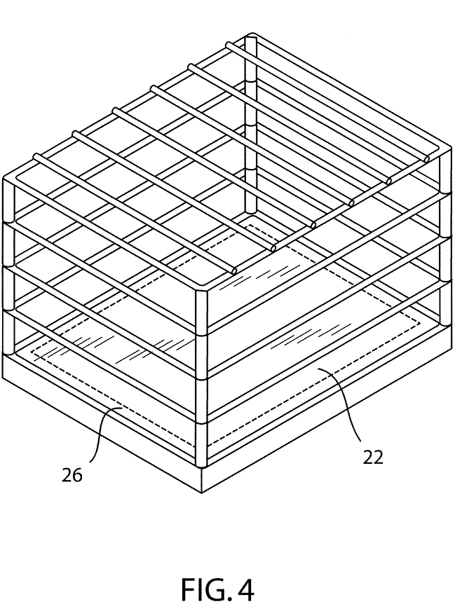

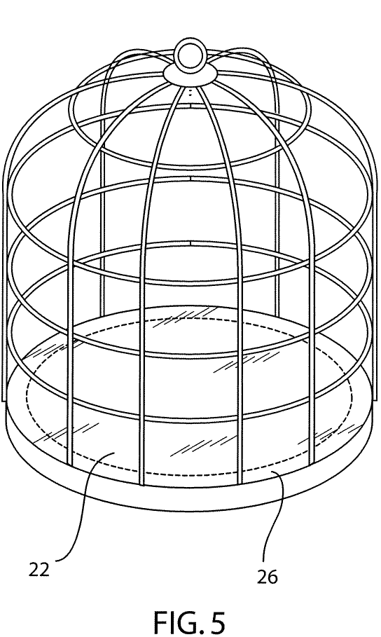

Additional embodiments of the invention need not be limited to restroom use. Other applications may include the use of sheets 22 for small animal cages (as illustrated in FIG. 4), bird cages (as illustrated in FIG. 5), shop table tops, temporary automobile mats (for use at detail shops, car washes, oil change businesses, etc.), photocopy repair (where photocopy toner could soil the floor of an establishment where a photocopier is being repaired), kitchen floors and foodservice areas of restaurants, and any other place where a user would benefit from the quick installation and removal afforded by a strip (or strips) of light to moderately tacky adhesive element 26 on an absorbent sheet 22 of paper or other material.

While the invention has been described in conjunction with specific embodiments, it is evident that many alternatives, modifications and variations will be apparent to those skilled in the art in light of the foregoing description. Accordingly, the present invention attempts to embrace all such alternatives, modifications and variations that fall within the spirit and scope of the appended claims.

1. A sheet for absorbing fluids and soils adjacent to the base of a urinal or toilet, comprising a sheet of absorbent material having an adhesive element on a bottom surface to releasably secure said sheet to a floor surface and wherein said sheet is configured to enable a user to stand upon said sheet.

2. The sheet of claim 1, wherein the adhesive element is segmented rather than continuous.

3. The sheet of claim 1, further including at least one item selected from a list of graphics, textures, and printed patterns on a top surface of said sheet.

4. The sheet of claim 1, further including text on a top surface of said sheet.

5. The sheet of claim 1, further including an advertisement on a top surface of said sheet.

6. A sheet for absorbing fluids and soils configured for placement at a floor of bird cage or animal cage, comprising a sheet of absorbent material having an adhesive element on a bottom surface to releasably secure said sheet to a floor of a bird cage or animal cage.

7. A pad comprising a plurality of sheets of disposable, absorbent material, said plurality of sheets including at least one adhesive element on a bottom surface and positioned vertically on top of one another to form a pad, wherein said adhesive element releasably connects said plurality of sheets to one another, and wherein said plurality of sheets may be releasably removed from a pad and adhesively secured to a floor.

8. A pad as defined in claim 7, further including a protective base sheet releasably connected to a bottommost sheet of said plurality of sheets.

9. A pad as defined in claim 7, wherein said plurality of sheets includes textures, graphics, or printed patterns on a top surface.

10. A pad as defined in claim 7, wherein said plurality of sheets includes text on a top surface.

11. A pad as defined in claim 7, wherein said plurality of sheets includes an advertisement on a top surface.

12. A pad as defined in claim 7, further including a prefabricated hole extending through said plurality of sheets.

13. A pad as defined in claim 7, further including cut-outs to allow a user to stand upon the floor surface.

14. A method of using a plurality of sheets to absorb fluids and soils, the method comprising the steps of:
removing a first sheet from a pad including a plurality of absorbent sheets;
adhesively securing said first sheet to a surface;
discarding said first sheet as it becomes soiled;
removing a second sheet from the pad; and
adhesively securing said second sheet to the surface.

15. The method of using a plurality of sheets as defined in claim 14, wherein the plurality of sheets includes a prefabricated hole and further including the step of storing the pad on a hook using the prefabricated hole.

16. The method of using a plurality of sheets as defined in claim 14, wherein the surface includes a floor surface adjacent a toilet.

17. The method of using a plurality of sheets as defined in claim 14, wherein the surface includes a floor surface adjacent a urinal.

18. The method of using a plurality of sheets as defined in claim 14, further including the step of using said removed sheet to clean other areas of a restroom.

19. A continuous roll for absorbing fluids and soils, comprising:
a spool;
a roll of a length of absorbent material having at least one adhesive element along at least one edge; and
wherein a section of said length of absorbent material is configured to be cut from said roll and releasably secured to a surface.
